(19) United States
(12) Patent Application Publication
(10) Pub. No.: US 2006/0170361 A1
(43) Pub. Date: Aug. 3, 2006

(54) Single-ended Arc Discharge Vessel with a Divider Wall

(75) Inventors: Lori R. Brock, Ipswich, MA (US); Thomas D. Dreeben, Swampscott, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 10/906,010

(22) Filed: Jan. 31, 2005

(51) Int. Cl. H01J 17/16; H01J 61/30

(52) U.S. Cl. 313/634; 313/573; 313/493

(57) ABSTRACT

A single-ended arc discharge vessel for a metal halide lamp includes a U-shaped arc discharge chamber that has two juxtaposed subchambers with a divider wall therebetween and a passageway around the divider wall that connects the two subchambers to each other. The vessel has two parallel electrodes in a same end of the vessel that is opposite the passageway. Each of the electrodes extends into a respective one of the two subchambers a distance less than a height of the divider wall so that the arc discharge between the electrodes is U-shaped. This arrangement moves the vessel cold spot away from the electrodes to permit higher operating temperatures and increases arc gap length for a given vessel size to permit a higher lamp voltage.

### BACKGROUND OF THE INVENTION

The present invention is directed to an arc discharge vessel for a metal halide lamp.

Prior art arc discharge vessels have temperature and size characteristics that have presented problems for designers of such vessels. In a typical linear configuration, electrodes are positioned on a central axis at opposite ends of the discharge vessel for striking an arc therebetween. The discharge vessel is hermetically sealed and contains a chemical fill that may comprise mercury and a mixture of metal halide salts, e.g., Nal, Cal₂, DyI₃, HoI₃, TmI₃, and TlI. The discharge chamber will also contain a buffer gas, e.g., 30 to 300 torr Xe or Ar. The arc discharge vessel is desirably operated at a relatively high temperature to vaporize the metal halide salts. In vertically operated lamps, the molten salt condensate in these vessels collects near the base of one or both of the electrodes since this is where the temperatures tend to be lowest, i.e., the cold spot. Examples of metal halide discharge vessels are described in U.S. Pat. Nos. 5,424,609, 6,525,476 and 6,620,272.

Ceramic materials such as polycrystalline alumina (PCA) are preferred for discharge vessels because they can withstand higher temperatures than quartz. This allows metal halide lamps to be operated at higher wall temperatures in order to vaporize more of the metal salts. However, linear ceramic discharge vessels do not fully utilize the high temperature resistance of ceramics. With the electrodes arranged on opposite ends, any rise in temperature will cause a temperature increase at both ends of the discharge vessel. This is problematic because the electrode feedthroughs are usually sealed to the ceramic vessel with a frit material, e.g., a Dy₂O₃—Al₂O₃—SiO₂ glass-ceramic, that has a lower melting point than the ceramic. The frit material is also more reactive with respect to the chemical fill. Therefore reactions between the molten metal halide salts (the melt) and the frit material are reduced if the frit material is kept cool and away the molten salts. The designers of such vessels have had difficulty finding ways to operate an arc discharge vessel at a high temperature while accommodating the temperature limitations of the frit material.

Another consideration is that a longer arc gap between the electrodes is needed for higher lamp operating voltages. However, a longer arc gap increases the overall length of the vessel. Lamp size constraints can limit the size of the vessel and therefore limit the lamp operating voltage. Further, in mercury-reduced or mercury-free lamps, the loss of mercury decreases lamp voltage which can make them incompatible with existing ballasts that are designed to operate at a higher lamp voltage. Therefore, it would be desirable to be able to increase lamp voltage for mercury-reduced lamps within the constraints of available lamp sizes and ballasts.

### SUMMARY OF THE INVENTION

An object of the present invention is to provide a novel single-ended arc discharge vessel that can be operated with part of the vessel at higher temperatures than available in the prior art.

A further object of the present invention is to provide a novel single-ended arc discharge vessel that provides a longer arc gap length for a given overall vessel length.

A yet further object of the present invention is to provide a novel single-ended arc discharge vessel that has a U-shaped arc discharge chamber and two electrodes that are next to each other at the same end of the vessel, where the two electrodes have end portions that are each in a different distal end of the U-shaped arc discharge chamber, thereby moving the vessel cold spot, and consequently the molten salt condensate, away from the electrodes.

Another object of the present invention is to provide a novel single-ended arc discharge vessel that includes an arc discharge chamber that has two juxtaposed subchambers with a divider wall therebetween and a passageway around the divider wall that connects the two subchambers to each other, and two parallel electrodes in a same end of the vessel that is opposite the passageway, where each of the electrodes extends into a respective one of the two subchambers a distance less than a height of the divider wall so that the arc discharge between the electrodes is essentially U-shaped.

These and other objects and advantages of the invention will be apparent to those of skill in the art of the present invention after consideration of the following drawings and description of preferred embodiments.

### BRIEF DESCRIPTION OF THE DRAWINGS

FIG. 1 is a pictorial representation of an embodiment of the arc discharge vessel of the present invention.

FIG. 2 is first cross section of the vessel of FIG. 1 showing the juxtaposed subchambers.

FIG. 3 is a second cross section of the vessel of FIG. 1 showing the passageway around the dividing wall.

FIG. 4 is a pictorial representation of a further embodiment of the vessel of the present invention showing the dividing wall with a gap.

FIG. 5 is a pictorial representation of a further embodiment of the vessel of the present invention showing the heat conducting member.

FIG. 6 is a pictorial representation of a further embodiment of the vessel of the present invention showing a rounded vessel shape.

FIG. 7 is a pictorial representation of a further embodiment of the vessel of the present invention showing another rounded vessel shape.

### DETAILED DESCRIPTION OF THE INVENTION

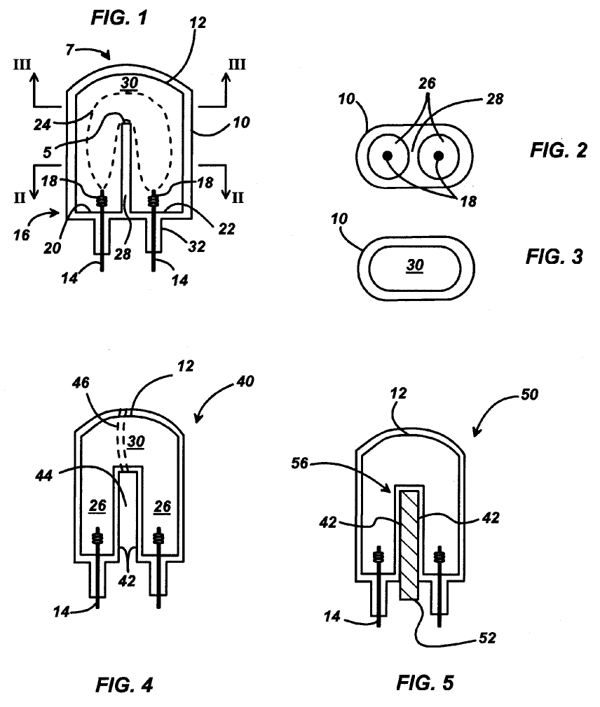

With reference now to FIGS. 1-3, an embodiment of the present invention is a single-ended arc discharge vessel 10 that is generally rectangular in cross section with a rounded end 7 at the top and that includes an arc discharge chamber 12 that is generally U-shaped and tubular. The vessel 10 has two electrodes 14 that are next to each other at a same end 16 of the vessel 10 and that have arc discharge forming portions 18 that are each in a different distal end 20, 22 of the arc discharge chamber 12 so that an arc discharge 24 between the arc discharge forming portions 18 is generally U-shaped. The electrodes 14 may be sealed to the capillaries 32 with a frit material.

As may be seen more clearly in FIGS. 2-3, the U-shaped arc discharge chamber 12 includes two juxtaposed subchambers 26 with a divider wall 28 therebetween and a passageway 30 around the divider wall 28 that connects the two subchambers 26 to each other. The arc discharge forming portions 18 of the two electrodes 14 extend into the subchambers 26 a distance less than the height of the divider wall 28 so that the discharge forming portions 18 are not in a line-of-sight with each other. As is apparent from the drawings, the divider wall 28 extends from one side of the arc discharge chamber 12 only part of a distance to an opposite side of the chamber. The dividing wall 28 is desirably centered in the chamber 12 so that the subchambers 26 are of equal size, although such equality is not required. The dividing wall 28 has a height that is less than half the desired arc gap length, taking into account the width of passageway 30 that is appropriate for the lamp. The passageway 30 need not have the same diameter as the subchambers 26.

In prior art vessels that have a linear arc discharge chamber containing a linear arc discharge, the electrodes are linearly aligned with each other so that their respective arc discharge forming ends are pointed at each other (they have an angle of 180° between them). By contrast, the electrodes 14 have their respective arc discharge forming ends 18 generally aligned with the respective axes of the distal ends 20, 22 of the chamber 12 to provide the U-shaped arc discharge 24 (like bending a prior art linear vessel in half). To this end, the arc discharge forming ends 18 may be parallel to each other so that the angle between them is 0°.

The capillaries 32 that encase the electrodes 14, the electrodes themselves, the respective feedthroughs, frit materials, and the chemistry of the vessel fill (e.g., metal halide salts) may be conventional and need not be discussed herein.

In operation, the vessel 10 has a non-isothermal arc vessel wall temperature distribution in which the top end 5 of the dividing wall 28 adjacent to the arc 24 has a higher temperature than other parts of the vessel. Indeed, the top end 5 of the dividing wall may reach over 1200° C., which is not typical of the prior art. Higher operating temperatures are desirable because more of the chemicals in the lamp will vaporize, bearing in mind that the photometric properties of the lamp depend, at least in part, on the vapor pressure of the metal halide. The vessel 10 may be made of polycrystalline alumina (PCA) or other material that can withstand such temperatures, e.g., aluminum oxynitride, aluminum nitride, sapphire, or yttrium aluminum garnet.

Unlike prior art linear vessels, the cold spot in the lamp is in the rounded top 7 of the vessel wall opposite from the capillaries 32 where the frit seals are typically found. The cold spot is further separated from the hot spot at the top end 5 of the dividing wall 28 by the passageway 30. The temperature difference between the hot and cold spots may be reduced by decreasing the width of the passageway 30. Movement of the cold spot away from the frit material at the electrode seals permits the use of higher temperatures to enhance the vaporization of the chemical fill, without accelerating harmful melt-frit reactions.

The vessel may be operated with the electrodes up or down; the hot and cold spots stay generally in the same places regardless of vessel orientation. However, it has been found that the temperature distribution in the vessel is more uniform and the arc discharge less constricted with the electrodes down.

Vessels of the prior art cannot take advantage of the high temperature tolerance of PCA and improve the vaporization of the chemicals because the frits that seal the electrodes are on opposite ends of the lamp. In the present invention, both frits that seal the electrodes are on the same end of the lamp, and the cold spot and melt are on the opposite end. Therefore, the whole discharge vessel can be operated at a higher temperature without accelerating harmful melt-frit reactions.

The U-shaped arc discharge formed by the structure described above also permits the use of longer arc gaps for a given vessel length, thereby allowing the use of the vessel of the present invention in a lamp operating at the same lamp voltage as a prior art vessel that is about twice as long. As noted above, this can be a significant improvement for lamps with less mercury. For example, a prior art 400 W arc vessel with mercury has an overall length of about 75 mm and needs 135V to operate with the standard M59 ballast. For a reduced mercury lamp to operate with the same ballast, the overall vessel length must be increased to 95-115 mm. The vessel of the present invention reduces overall length by moving the capillaries to one end (saving 25 mm in this example) and by nearly halving the vessel length.

Another advantage of the vessel of the present invention is that placing a longer arc in a smaller vessel improves the focusing of the light from the vessel because existing lamp fixtures are optimized to focus light with shorter arcs. That is, the vessel of the present invention behaves more like a point source than prior art vessels. In addition, since the electrodes are at the same end of the vessel, there is no return wire. This can be a significant improvement in reflector lamps.

In a further embodiment 40 shown in FIG. 4, the dividing wall is formed by the interior walls 42 of the two subchambers 26 that have a gap 44 between them. The gap may be open to the ambient environment and may have a size appropriate for the type of lamp. A gap width of approximately 5 mm has been found to be suitable in a test lamp. In this embodiment, a heat sink to carry heat away from the hot spot at the top end of the dividing wall may be provided by wrapping a heat conducting wire 46 around the passageway 30 at the upper end of the gap 44.

In yet a further embodiment 50 shown in FIG. 5, the dividing wall includes a heat conductive member 52, such as heat conductive metal, that carries heat away from the interior walls 42 of the arched interior portion 56 of the arc discharge chamber 12 to an external heat sink (not shown).

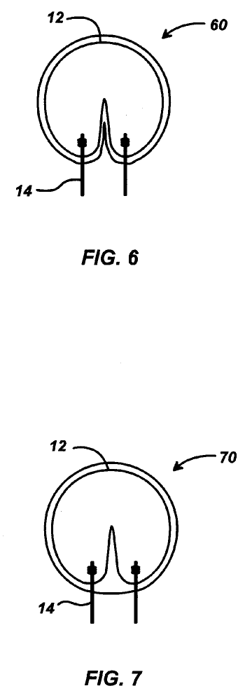

Two additional embodiments are shown in FIGS. 6-7. The vessels 60, 70 have rounded shapes to help control vessel temperature.

In any of the embodiments, it is possible to control and decrease the dividing wall temperature by making the dividing wall thicker.

While embodiments of the present invention have been described in the foregoing specification and drawings, it is to be understood that the present invention is defined by the following claims when read in light of the specification and drawings.

What is claimed is:

1. A single-ended arc discharge vessel comprising a U-shaped arc discharge chamber containing a metal halide salt mixture, and two electrodes that are next to each other at a same end of said vessel and that have arc discharge forming portions that are each in a different distal end of said U-shaped arc discharge chamber so that an arc discharge between said end portions is U-shaped.

2. The vessel of claim 1, wherein said U-shaped arc discharge chamber comprises two juxtaposed subchambers with a divider wall therebetween and a passageway around said divider wall that connects said two subchambers to each other.

3. The vessel of claim 2, wherein said arc discharge forming portions of said two electrodes extend into said subchambers a distance less than a height of said divider wall.

4. The vessel of claim 2, wherein said divider wall comprises a heat conductive member that conducts heat away from an interior wall of an arched interior portion of said arc discharge chamber.

5. The vessel of claim 2, wherein said divider wall comprises two interior walls of said arc discharge chamber and a hollow space between said two interior walls.

6. The vessel of claim 1, wherein said arc discharge forming portions of said two electrodes are not in a line-of-sight with each other.

7. The vessel of claim 1, wherein the vessel in cross-section is generally rectangular with a rounded end opposite said end with said two electrodes.

8. The vessel of claim 1, wherein the vessel in cross section is generally round.

9. The vessel of claim 1, wherein said arc discharge forming portions of said two electrodes are parallel to each other.

10. A single-ended arc discharge vessel comprising:
an arc discharge chamber with a divider wall therein that extends from one side of said chamber only part of a distance to an opposite side of said chamber, the arc discharge chamber containing a metal halide salt mixture; and
two parallel electrodes next to each other at one end of the vessel, each of said two electrodes extending into said chamber on a different side of said divider wall less than a height of said divider wall.

11. The vessel of claim 10, wherein said divider wall comprises a heat conductive member that conducts heat away from said arc discharge chamber.

12. The vessel of claim 10, wherein said divider wall comprises two interior walls of said arc discharge chamber and a hollow space between said two interior walls.

13. The vessel of claim 10, wherein the vessel in cross-section is generally rectangular with a rounded end opposite said end with said two electrodes.

14. The vessel of claim 10, wherein the vessel in cross section is generally round.

15. A single-ended arc discharge vessel comprising:
an arc discharge chamber that has two juxtaposed subchambers with a divider wall therebetween and a passageway around said divider wall that connects said two subchambers to each other, the arc discharge chamber containing a metal halide salt mixture; and
two electrodes in a same end of the vessel opposite said passageway that each extends into a respective one of said two subchambers a distance less than a height of said divider wall so that an arc discharge between said two electrodes is U-shaped.

16. The vessel of claim 15, wherein said divider wall comprises a heat conductive member that conducts heat away from an interior side of an arched portion of said arc discharge chamber.

17. The vessel of claim 15, wherein said divider wall comprises two interior walls of said arc discharge chamber and a hollow space between said two interior walls.

18. The vessel of claim 15, wherein arc discharge forming portions of said two electrodes are parallel to each other.

19. The vessel of claim 15, wherein a diameter of said passageway is no greater than a diameter of said subchambers.
